(19) United States
(12) Patent Application Publication
(10) Pub. No.: US 2026/0358954 A1
(43) Pub. Date: Nov. 12, 2026

(54) DYNAMICALLY MANAGING STORAGE NODE SELECTION FOR SUSTAINABILITY

(71) Applicant: International Business Machines Corporation, Armonk, NY (US)

(72) Inventors: Charan ACHARYA CHANDRASHEKAR, Bangalore (IN); Rachana VISHWANATHULA, Hyderabad (IN); Raja RAHUL, Visakhapatnam (IN); Hemant Kumar SIVASWAMY, Bangalore (IN)

(21) Appl. No.: 19/203,616

(22) Filed: May 9, 2025

(51) Int. Cl. G06F 3/06; G06F 11/30

(52) U.S. Cl. CPC G06F 3/0604; G06F 3/0638; G06F 3/067; G06F 11/3034; G06F 11/3058

(57) ABSTRACT

In some implementations, a computer system may determine internal factors influencing carbon and generated heat footprints of a plurality of storage nodes of a system with a width, a write threshold, and a read threshold, and may determine external factors influencing the carbon and generated heat footprints of the plurality of storage nodes. The computer system may predict dynamic factors influencing the carbon and generated heat footprints of the plurality of storage nodes. The computer system may calculate respective sustainability ratings for the plurality of storage nodes based on the internal factors, the external factors, and the dynamic factors, and may utilize the sustainability ratings to manage the system.

### BACKGROUND

This disclosure relates to object storage, and more specifically, to dynamically managing storage node selection for sustainability and object storage.

### SUMMARY

Some aspects described herein relate to a method. The method may include determining internal factors influencing carbon and generated heat footprints of a plurality of storage nodes of a system with a width, a write threshold, and a read threshold, and determining external factors influencing the carbon and generated heat footprints of the plurality of storage nodes. The method may include predicting dynamic factors influencing the carbon and generated heat footprints of the plurality of storage nodes. The method may include calculating respective sustainability ratings for the plurality of storage nodes based on the internal factors, the external factors, and the dynamic factors, and utilizing the sustainability ratings to manage the system.

Some aspects described herein relate to a computer system. The computer system may include a processor set, one or more computer-readable storage media, and program instructions stored on the one or more computer-readable storage media to cause the processor set to perform operations. The operations may include determining internal factors influencing carbon and generated heat footprints of a plurality of storage nodes of a system with a width, a write threshold, and a read threshold, wherein the internal factors include one or more of a hardware efficiency, a workload intensity, a layout and design, a cooling systems efficiency, a cooling efficiency, or renewable energy usage associated with each of the plurality of storage nodes. The operations may include determining external factors influencing the carbon and generated heat footprints of the plurality of storage nodes, and predicting dynamic factors influencing the carbon and generated heat footprints of the plurality of storage nodes. The operations may include calculating respective sustainability ratings for the plurality of storage nodes based on the internal factors, the external factors, and the dynamic factors, and utilizing the sustainability ratings to manage the system.

Some aspects described herein relate to a computer program product. The computer program product may include one or more computer-readable storage media and program instructions stored on the one or more computer-readable storage media to perform operations. The operations may include determining internal factors influencing carbon and generated heat footprints of a plurality of storage nodes of a system with a width, a write threshold, and a read threshold. The operations may include determining external factors influencing the carbon and generated heat footprints of the plurality of storage nodes, wherein the external factors include one or more of a climate, a geographical location, or an electricity grid carbon intensity associated with the system. The operations may include predicting dynamic factors influencing the carbon and generated heat footprints of the plurality of storage nodes. The operations may include calculating respective sustainability ratings for the plurality of storage nodes based on the internal factors, the external factors, and the dynamic factors, and utilizing the sustainability ratings to manage the system.

### BRIEF DESCRIPTION OF THE DRAWINGS

FIG. 1 is a diagram of an example computing environment for dynamically managing storage node selection for sustainability, as described herein.

FIGS. 2A-2F are diagrams of an example associated with dynamically managing storage node selection for sustainability.

FIG. 3 is a flowchart of an example process associated with dynamically managing storage node selection for sustainability.

### DETAILED DESCRIPTION

The following detailed description of example implementations refers to the accompanying drawings. The same reference numbers in different drawings may identify the same or similar elements.

Sustainability is an ability of a system, process, or practice to maintain a current level of performance, productivity, or viability over time, while minimizing its negative impact on the environment. Organizations have been facing increasing pressure to meet sustainability goals and reduce their carbon footprint. The growing reliance on data centers and object storage systems has led to a significant rise in energy consumption, greenhouse gas emissions, and heat generation. In particular, object storage systems, which manage data as independent units called objects, are widely used in cloud storage and have become a significant contributor to the overall carbon footprint of data centers.

Current object storage systems typically prioritize performance and speed, and select storage nodes based on response times or latencies associated with the storage nodes. However, this approach neglects the sustainability aspect, failing to account for the carbon emissions and heat generated by the storage nodes during object storage and retrieval. As a result, current object storage systems often store/retrieve slices of an object to/from storage nodes with high energy consumption and carbon footprint. The lack of a sustainable object storage system has severe consequences, including increased energy consumption, greenhouse gas emissions, and heat generation. Thus, current methods for managing object storage systems consume computing resources (e.g., processing resources, memory resources, communication resources, and/or the like), networking resources, and/or the like associated with managing increased energy consumption associated with object storage systems, handling legal and environmental implications of neglecting sustainability in object storage systems, managing increased heat generation associated with object storage systems, and/or the like.

Some implementations described herein provide a computer system for dynamically managing storage node selection for sustainability. For example, the computer system may determine internal factors influencing carbon and generated heat footprints of a plurality of storage nodes of a system with a width, a write threshold, and a read threshold, and may determine external factors influencing the carbon and generated heat footprints of the plurality of storage nodes. The computer system may predict dynamic factors influencing the carbon and generated heat footprints of the plurality of storage nodes. The computer system may calculate respective sustainability ratings for the plurality of storage nodes based on the internal factors, the external factors, and the dynamic factors, and may utilize the sustainability ratings to manage the system.

In this way, the computer system dynamically manages storage node selection for sustainability. For example, the computer system may analyze metrics influencing carbon and heat generation footprints of all storage nodes in an object storage system and may update sustainability ratings for each storage node based on the metrics analysis. The computer system may predict dynamically changing metrics that impact the sustainability, and may read or write slices of objects from or to the storage nodes with high sustainability ratings, ensuring that generated carbon footprint and heat are relatively low. Thus, the computer system may reduce heat generated by the object storage system, may increase utilization of renewable energy sources, and may minimize the need for excessive cooling and energy consumption in the object storage system. Thus, the computer system conserves computing resources, networking resources, and/or the like that would otherwise have been consumed by managing increased energy consumption associated with object storage systems, handling legal and environmental implications of neglecting sustainability in object storage systems, managing increased heat generation associated with object storage systems, and/or the like.

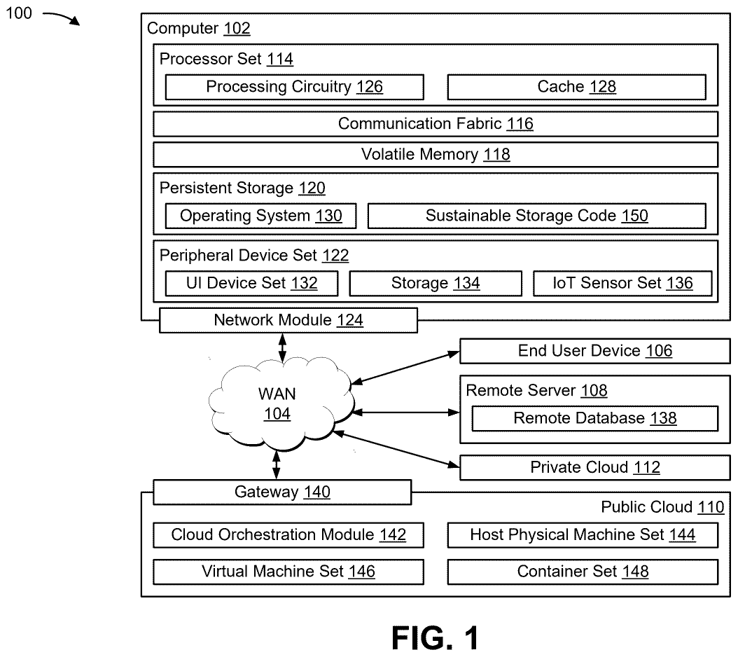

FIG. 1 is a diagram of an example computing environment 100 for dynamically managing storage node selection for sustainability, as described herein.

Computing environment 100 contains an example of an environment for the execution of at least some of the computer code involved in performing the inventive methods, such as sustainable storage code 150 (e.g., code for dynamically managing storage node selection for sustainability). In addition to sustainable storage code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and sustainable storage code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in sustainable storage code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

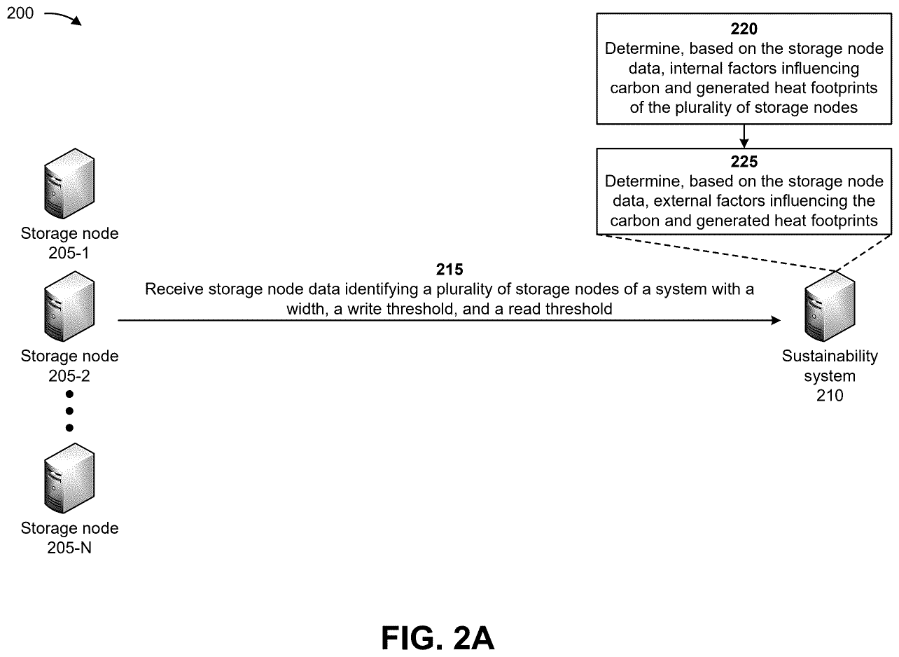

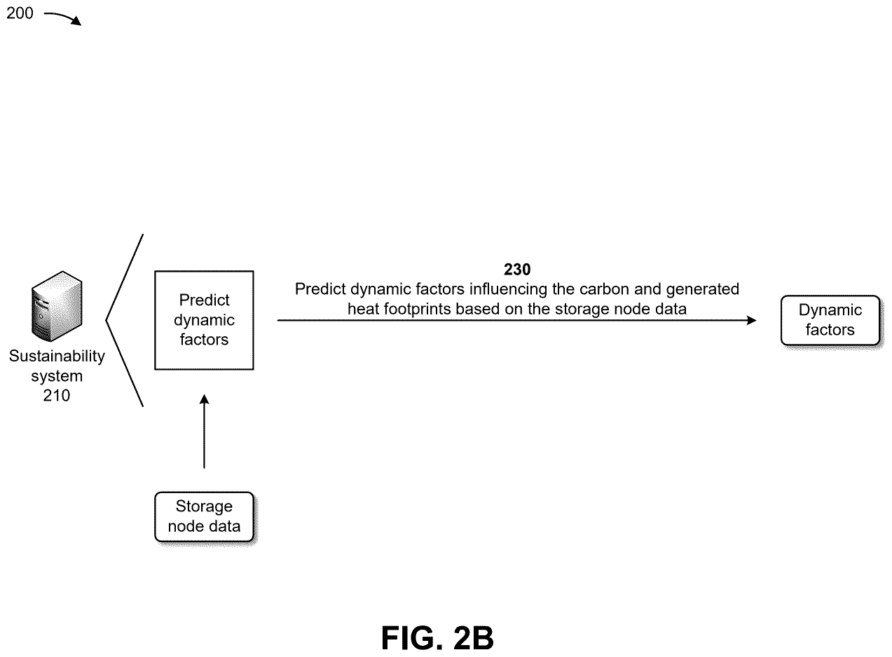

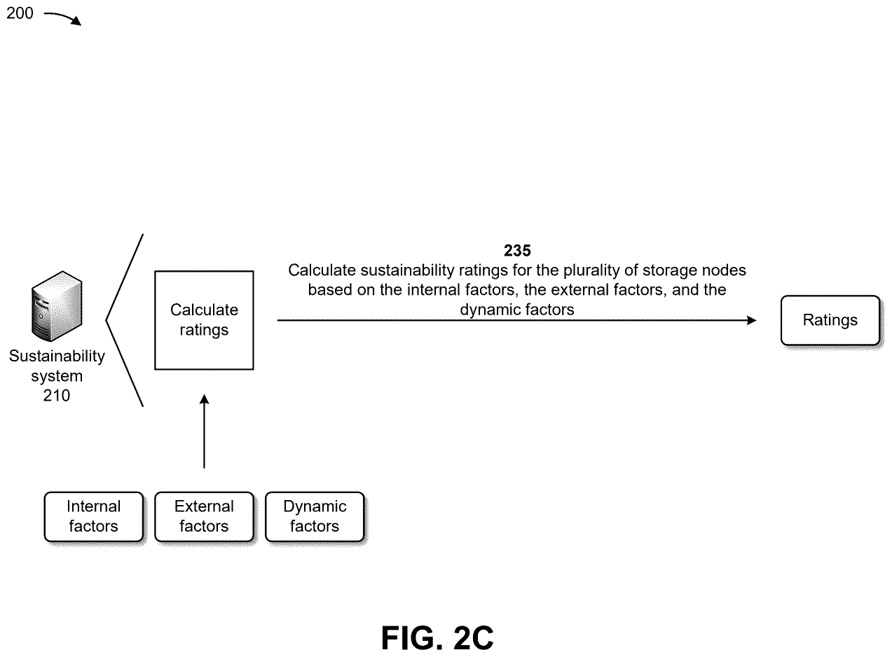

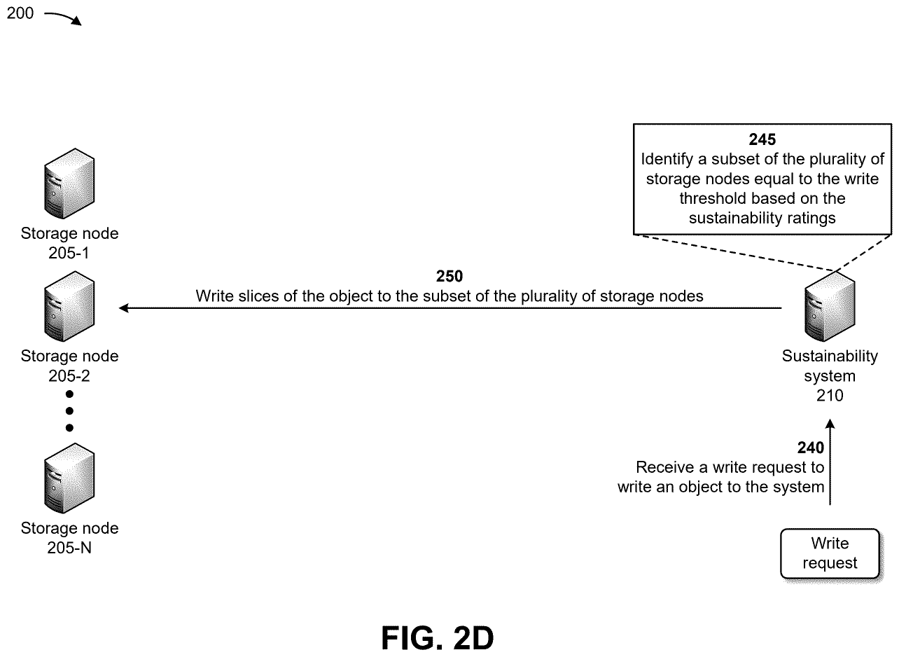

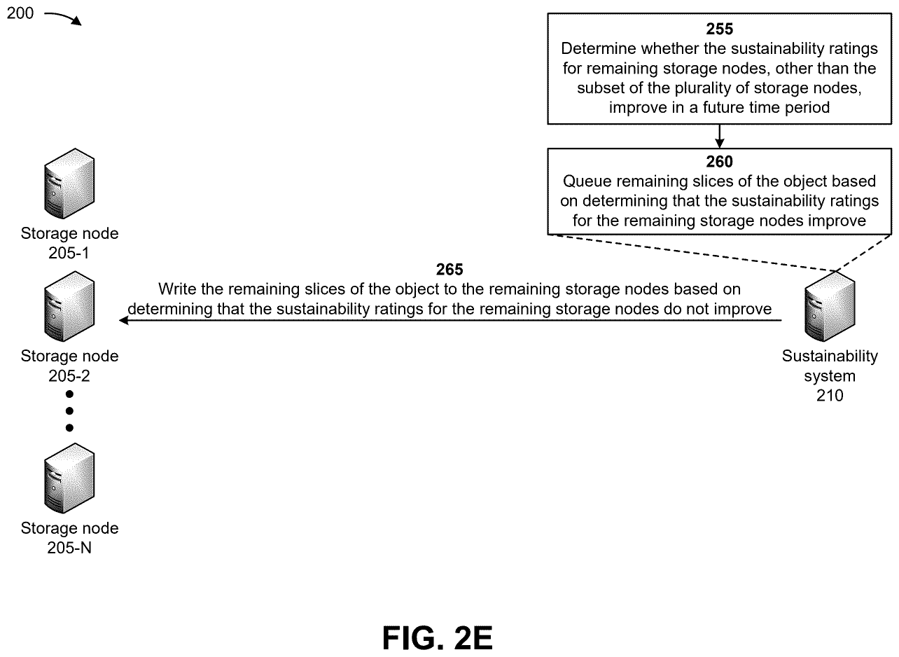

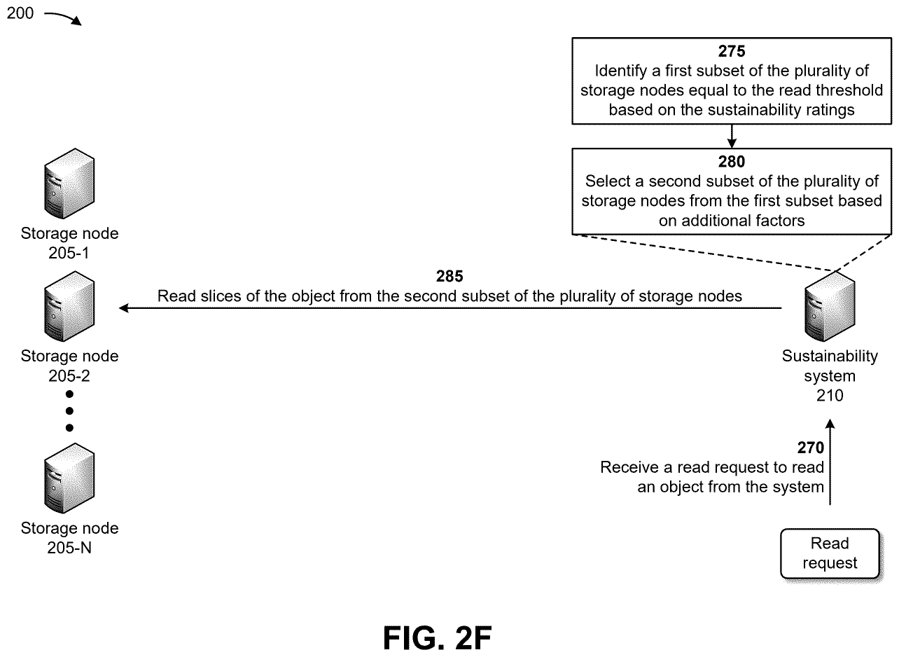

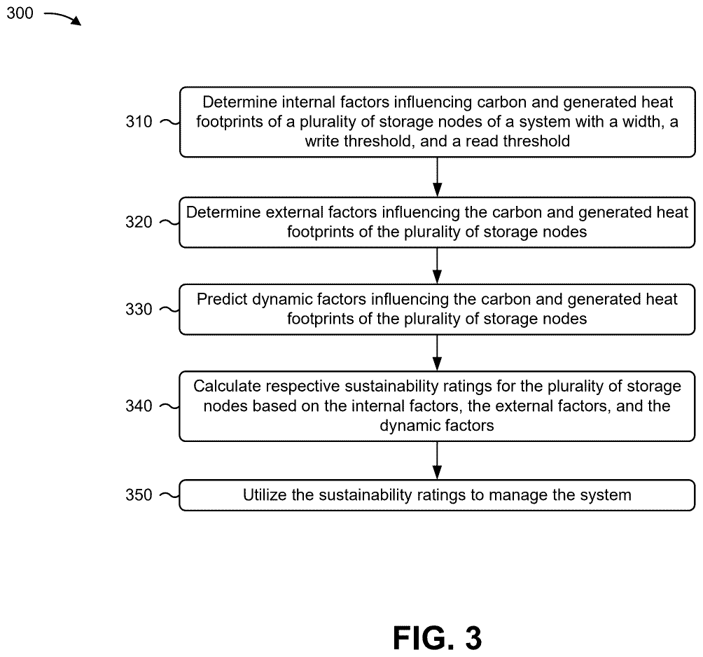

The code included in the sustainable storage code 150 typically includes at least some of the computer code involved in performing one or more operations described herein, such as the operations of implementation 200 in FIGS. 2A-2F and the process described in FIG. 3.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

FIGS. 2A-2F are diagrams of an example 200 associated with dynamically managing storage node selection for sustainability. As shown in FIGS. 2A-2F, the example 200 includes a plurality of storage nodes 205 (e.g., storage node 205-1 through 205-N) associated with a sustainability system 210. Each of the plurality of storage nodes 205 and the sustainability system 210 may correspond to the computer 102, the remote server 108, a system provided by the public cloud 110, and/or a system provided by the private cloud 112. Further details of the plurality of storage nodes 205 and the sustainability system 210 are provided elsewhere herein.

As shown in FIG. 2A, and by reference number 215, the sustainability system 210 may receive storage node data identifying the plurality of storage nodes 205 of a system with a width, a write threshold, and a read threshold. For example, a system (e.g., an object storage system) may include the plurality of storage nodes 205. The system may be responsible for object storage (e.g., storing and managing data as distinct, discrete units called objects). Unlike traditional file systems that organize data in a hierarchical structure with directories and files, an object storage system may store data as independent objects, each with its own unique identifier. A container for objects may include a bucket that stores a collection of objects. Objects stored within a bucket may include files, documents, images, videos, or any other type of data that is stored as discrete units. An erasure coding/information dispersal model of data protection and redundancy may be utilized in an object storage system to ensure durability and reliability of stored data. In the erasure coding/information dispersal model, data may be divided into multiple non-identical slices and distributed across different storage nodes. A width may specify a number of storage nodes in the object storage system. A write threshold may specify a minimum number of slices of an object that must be successfully written to the storage nodes before considering a write operation to be complete. A read threshold may specify a minimum number of slices of an object that must be successfully read from the storage nodes to reconstruct original data during a read operation.

In some implementations, the sustainability system 210 may continually receive the storage node data identifying the plurality of storage nodes 205 of the system with the width, the write threshold, and the read threshold, may periodically receive the storage node data, may receive the storage node data based on requesting the storage node data from the system, and/or the like. In some implementations, the sustainability system 210 may store the storage node data in a data structure (e.g., a database, a list, a table, and/or the like) associated with the sustainability system 210.

In some implementations, the sustainability system 210 may use various methods to collect and analyze the storage node data. For example, the sustainability system 210 may utilize agent-based monitoring that deploys software agents on each storage node 205 to collect and transmit the storage node data to the sustainability system 210. The sustainability system 210 may utilize simple network management protocol (SNMP)-based monitoring to collect the storage node data, may analyze system logs to determine the storage node data, may utilize application programming interfaces (APIs) to collect the storage node data, and/or the like. In some implementations, the sustainability system 210 may utilize historical data and predictive modeling to estimate the storage node data based on workload patterns and storage capacity utilization.

As further shown in FIG. 2A, and by reference number 220, the sustainability system 210 may determine, based on the storage node data, internal factors influencing carbon and generated heat footprints of the plurality of storage nodes 205. For example, the internal factors may include characteristics or attributes that are inherent to the plurality of storage nodes 205 and can impact the carbon and heat footprints of the plurality of storage nodes 205. In some implementations, the internal factors influencing the carbon and generated heat footprints of the plurality of storage nodes 205 may include hardware efficiencies associated with the plurality of storage nodes 205, workload intensities associated with the plurality of storage nodes 205, a layout and design associated with the plurality of storage nodes 205, cooling systems efficiencies associated with the plurality of storage nodes 205, cooling efficiencies associated with the plurality of storage nodes 205, renewable energy usages associated with the plurality of storage nodes 205, and/or the like.

The sustainability system 210 may analyze the storage node data to determine the hardware efficiency of each of the plurality of storage nodes 205. This may include factors such as a server type and model (e.g., different server models have varying levels of power consumption and heat generation), storage capacity (e.g., higher storage capacities often require more power and generate more heat), age and maintenance history (e.g., older or poorly maintained hardware may be less efficient and generate more heat), type of storage media used such as hard disk drives, solid-state drives, and tape drives (e.g., different storage media have varying levels of power consumption and heat generation), and/or the like. The sustainability system 210 may analyze the storage node data to determine the workload intensity of each of the plurality of storage nodes 205. This may include factors such as data throughput (e.g., higher data throughput rates may require more power and generate more heat), request rates (e.g., higher request rates may require more power and generate more heat), a type of workload (e.g., different workloads, such as streaming, transactional, or batch processing, have varying levels of power consumption and heat generation), and/or the like.

The sustainability system 210 may analyze the storage node data to determine the layout and design of each storage node 205. This may include factors such as a data center layout (e.g., poorly designed data centers may lead to hotspots and inefficiencies in cooling systems), a rack density (e.g., higher rack densities may lead to increased power consumption and heat generation), cable management (e.g., poor cable management can lead to increased heat generation and reduced airflow), and/or the like. The sustainability system 210 may analyze the storage node data to determine the efficiency of the cooling systems used in each storage node 205. This may include factors such as a type of cooling system (e.g., different cooling systems, such as air cooling or liquid cooling, have varying levels of efficiency and power consumption), a cooling capacity (e.g., higher cooling capacities may require more power and generate more heat), age and maintenance history (e.g., older or poorly maintained cooling systems may be less efficient and generate more heat), and/or the like.

The sustainability system 210 may analyze the storage node data to determine the cooling efficiency of each storage node 205. This may include factors such as ambient temperature (e.g., higher ambient temperatures may require more power and generate more heat), humidity levels (e.g., higher humidity levels may reduce cooling efficiency and increase power consumption), airflow rates (e.g., poor airflow rates may reduce cooling efficiency and increase power consumption), and/or the like. The sustainability system 210 may analyze the storage node data to determine the amount of renewable energy used by each storage node 205. This may include factors such as renewable energy source (e.g., different renewable energy sources, such as solar, wind, and hydroelectric, have varying levels of power generation and carbon footprint), renewable energy capacity (e.g., higher renewable energy capacities may reduce reliance on non-renewable energy sources and decrease carbon footprint), and/or the like.

By combining data from these sources, the sustainability system 210 can create a comprehensive view of the internal factors influencing the carbon and generated heat footprints of the plurality of storage nodes 205.

As further shown in FIG. 2A, and by reference number 225, the sustainability system 210 may determine, based on the storage node data, external factors influencing the carbon and generated heat footprints. For example, the external factors influencing the carbon and generated heat footprints of the plurality of storage nodes 205 may include influences that originate from outside the plurality of storage nodes 205, such as environmental conditions, location-specific characteristics, and properties of a power grid used by the plurality of storage nodes 205. The external factors may include climates associated with the plurality of storage nodes 205, geographical locations associated with the plurality of storage nodes 205, electricity grid carbon intensities associated with the plurality of storage nodes 205, and/or the like.

In some implementations, the sustainability system 210 may analyze the geographical location of each storage node 205 to determine factors such as local climate, temperature, and humidity. These factors can influence the cooling requirements and energy consumption of the storage nodes 205. For example, a storage node 205 located in a hot and humid climate may require more cooling, which increases energy consumption and carbon footprint. Conversely, a storage node 205 located in a cold climate may require less cooling, resulting in lower energy consumption and a smaller carbon footprint.

Alternatively, or additionally, the sustainability system 210 may collect data on local climate and weather patterns, including temperature, humidity, wind patterns, and solar irradiance. This data may enable the sustainability system 210 to predict the energy requirements of the storage nodes 205 and the potential for using renewable energy sources. For example, a storage node 205 located in an area with abundant solar resources may be able to use solar power to reduce reliance on non-renewable energy sources. Similarly, a storage node 205 located in an area with consistent wind patterns may be able to use wind power to reduce energy consumption.

Alternatively, or additionally, the sustainability system 210 may analyze properties of a power grid used by each storage node 205, including a carbon intensity and an availability of renewable energy sources in the power grid. For example, a storage node 205 connected to a power grid with high carbon intensity (i.e., a grid that relies heavily on fossil fuels) will have a larger carbon footprint than a storage node 205 connected to a grid with low carbon intensity (i.e., a grid that uses more renewable energy sources). Alternatively, or additionally, the sustainability system 210 may collect data on local air quality and pollution levels, which can impact the operation and maintenance of the storage nodes 205. Poor air quality may reduce the efficiency of cooling systems of a storage node 205, leading to increased energy consumption and a larger carbon footprint.

Alternatively, or additionally, the sustainability system 210 may analyze data on water availability and usage patterns in the areas where the storage nodes 205 are located. This data can help identify opportunities for reducing water consumption and mitigating the environmental impact of the storage nodes 205. For example, a storage node 205 located in an area with limited water resources may require more energy-intensive cooling systems, increasing the carbon footprint. Conversely, a storage node 205 located in an area with abundant water resources may be able to use water-based cooling systems, reducing energy consumption and the carbon footprint. Alternatively, or additionally, the sustainability system 210 may analyze the proximity of each storage node 205 to renewable energy sources, such as solar farms, wind farms, or hydroelectric power plants. This data can help identify opportunities for reducing the carbon footprint of the storage nodes 205 by using renewable energy sources.

As shown in FIG. 2B, and by reference number 230, the sustainability system 210 may predict dynamic factors influencing the carbon and generated heat footprints based on the storage node data. For example, the dynamic factors may include one or more of the internal factors and/or one or more of the external factors that are expected to change over time, such as the weather, loads on the plurality of storage nodes 205, the availability of renewable energy sources, and/or the like. In some implementations, the sustainability system 210 may utilize various prediction models to predict dynamic factors influencing the carbon and generated heat footprints based on the storage node data. The prediction model may be based on machine learning models, statistical models, or a combination of both.

In some implementations, the sustainability system 210 collects historical data from various sources, including the storage node data, weather forecasts, and energy usage patterns. The historical data may include temperature, humidity, wind speed, solar irradiance, and energy consumption data. The sustainability system 210 may preprocess (e.g., clean, transform, normalize, and/or the like) the collected data to ensure that the data is in a suitable format for the prediction model. The sustainability system 210 may utilize the preprocessed data to extract relevant features that can be used to train the prediction model. For example, the sustainability system 210 may extract features such as a daily average temperature, a daily average energy consumption, a daily average solar irradiance, and/or the like. The sustainability system 210 may select a suitable prediction model based on the type of dynamic factor being predicted. For example, a linear regression model may be used to predict energy consumption, while a decision tree model may be used to predict the availability of renewable energy sources. The sustainability system 210 may train the selected prediction models using the historical data and the extracted features. The prediction models may learn patterns and relationships between the input data and may predict the dynamic factors. The sustainability system 210 may evaluate the trained models using metrics, such as mean absolute error (MAE), mean squared error (MSE), or root mean squared percentage error (RMSPE). Once the models are trained and evaluated, the sustainability system 210 may utilize the prediction models to make predictions on future dynamic factors influencing the carbon and generated heat footprints.

In some implementations, the prediction models may include an autoregressive integrated moving average (ARIMA) model. The ARIMA model may be utilized for time series forecasting and to predict energy consumption or temperature. Alternatively, or additionally, the prediction models may include a support vector regression (SVR) model that uses support vector machines to predict continuous variables, a long short-term memory (LSTM) recurrent neural network model that predicts time series data, a decision tree model that predicts categorical variables such as the availability of renewable energy sources, a random forest model that combines multiple decision tree models to improve prediction accuracy, and/or the like. The prediction models may be trained using various data sources, including historical weather data (e.g., used to predict future weather patterns, which can impact the carbon and generated heat footprints), energy usage patterns (e.g., used to predict energy consumption, which can impact the carbon footprint), renewable energy source availability (e.g., used to predict the availability of renewable energy sources, which can impact the carbon footprint), sensor data (e.g., used to predict temperature, humidity, and other environmental factors that can impact the generated heat footprint), external data sources (e.g., weather forecasts, energy market data, or government regulations), and/or the like.

As shown in FIG. 2C, and by reference number 235, the sustainability system 210 may calculate respective sustainability ratings for the plurality of storage nodes 205 based on the internal factors, the external factors, and the dynamic factors. For example, the sustainability system 210 may preprocess data identifying the internal factors, the external factors, and the dynamic factors to ensure that the data is in a suitable format for calculation of the sustainability ratings. The preprocessing may include cleaning and filtering the data to remove any errors or inconsistencies, normalizing the data to a common scale (e.g., zero to one) to enable comparison across different factors, aggregating the data into a single value for each factor (e.g., average power consumption or average temperature), and/or the like. The sustainability system 210 may assign weights to each of the internal factors, each of the external factors, and each of the dynamic factors based on their relative importance in determining sustainability. For example, the sustainability system 210 may assign a weight of 40% to the internal factors (e.g., where hardware efficiency includes a weight of 15%, workload intensity includes a weight of 10%, layout and design includes a weight of 5%, cooling systems efficiency includes a weight of 5%, and renewable energy usage includes a weight of 5%); a weight of 30% to the external factors (e.g., where climate and geographical location includes a weight of 15%, electricity grid carbon intensity includes a weight of 10%, and local air quality and pollution levels include a weight of 5%); and a weight of 30% to the dynamic factors (e.g., where predicted energy consumption and heat generation includes a weight of 15%, predicted availability of renewable energy sources includes a weight of 10%, and predicted changes in workload intensity includes a weight of 5%).

The sustainability system 210 may calculate a sustainability rating for each of the plurality of storage nodes 205 using the preprocessed data and the assigned weights. In one example, the sustainability rating may be calculated using a formula, such as:

Sustainability rating

=(Internal factors×internal weight)

+(External factors×external weight)

+(Dynamic factors×dynamic weight).

where:

Internal factors

=(Hardware efficiency+Workload intensity

+Layout ∧design+Cooling systems efficiency

+Renewable energy usage/5,

External Factors

=(Climate∧geographical location

+Electricity grid carbon intensity

+Local air quality and pollution levels)/3.

Dynamic factors

=(Predicted energy consumption∧heat generation

+Predicted availability of renewable energy sources

+Predicted changes in workload intensity)/3.

In some implementations, the sustainability system 210 may utilize other formulas to calculate the sustainability rating.

The sustainability system 210 may normalize the sustainability ratings to a common scale (e.g., zero to one hundred) to enable comparison across the plurality of storage nodes 205. The sustainability system 210 may rank the plurality of storage nodes 205 based on the sustainability ratings, with higher ratings indicating better sustainability performance. The resulting sustainability ratings may provide a comprehensive assessment of the environmental sustainability of each of the plurality of storage nodes 205, taking into account both internal and external factors, as well as dynamic changes in workload intensity and renewable energy availability. The sustainability system 210 may utilize the sustainability ratings to make informed decisions about storage node 205 selection, resource allocation, and energy efficiency optimization.

In some implementations, the sustainability system 210 may periodically update the sustainability ratings for the plurality of storage nodes 205. For example, the sustainability system 210 may periodically receive new storage node data, and may determine updates to one or more of the internal factors, one or more of the external factors, and/or one or more of the dynamic factors based on the new storage data. The sustainability system 210 may calculate updated sustainability ratings for the plurality of storage nodes 205 based on the updates to the one or more of the internal factors, the one or more of the external factors, and/or the one or more of the dynamic factors.

As shown in FIG. 2D, and by reference number 240, the sustainability system 210 may receive a write request to write an object to the system. For example, the sustainability system 210 may receive the write request to write an object to the system from an external source, such as an application, a user, or another system. The write request may be in the form of an API call, a message, or a command. In some implementations, the write request may include object metadata (e.g., an object identifier, an object size, and an object type), object data (e.g., a file, a block, a stream, and/or the like), and write parameters (e.g., a write type, a priority, and a consistency level).

The sustainability system 210 may authenticate the write request to ensure that a requesting entity has the necessary permissions to write to the system. This may include verifying the requesting entity's identity (e.g., a username, a password, a token, and/or the like), checking the requesting entity's access control permissions (e.g., read, write, and/or delete), and validating the write request against any specific access policies or rules. In some implementations, the sustainability system 210 may validate the object data to ensure that the object data conforms to the system's requirements and constraints. This may include checking the object size and format, verifying the object's consistency and integrity (e.g., checksum and digital signature), and validating the object against any specific data policies or rules. In some implementations, the sustainability system 210 may determine the write type based on the write parameters. This may include checking the write type (e.g., synchronous, asynchronous, or batched), and verifying the consistency level (e.g., strong, weak, or eventual).

As further shown in FIG. 2D, and by reference number 245, the sustainability system 210 may identify a subset of the plurality of storage nodes 205 equal to the write threshold based on the sustainability ratings. For example, the sustainability system 210 may retrieve (e.g., from a data structure) the sustainability ratings calculated for the plurality of storage nodes 205. In some implementations, the sustainability system 210 may filter the plurality of storage nodes 205 based on the sustainability ratings by selecting only those storage nodes 205 that satisfy a minimum sustainability threshold. This threshold may be set based on the system's overall sustainability goals, energy efficiency targets, and/or carbon footprint reduction objectives. The sustainability system 210 may sort the filtered storage nodes 205 in a descending order list based on the sustainability ratings of the filtered storage nodes 205. This may ensure that the storage nodes 205 with the highest sustainability ratings are prioritized for selection. The sustainability system 210 may select a subset of the sorted and filtered storage nodes 205 with a quantity equal to the write threshold (N). This may include selecting the top N storage nodes 205 with the highest sustainability ratings.

In some implementations, the sustainability system 210 may verify availabilities of the selected storage nodes 205 to ensure that the selected storage nodes 205 are online and ready to handle the write operation. This may include checking the statuses, workloads, and capacities of the selected storage nodes 205. If one or more of the selected storage nodes 205 are not available, the sustainability system 210 may re-select storage nodes 205 from the sorted list to replace any unavailable storage nodes 205. This may ensure that the write operation can still be completed with the required number of storage nodes 205. The sustainability system 210 may finalize the subset of storage nodes 205 for use in the write operation. In some implementations, the sustainability system 210 may identify the subset of the plurality of storage nodes 205 by utilizing a weighted random selection instead of a top-N selection, by incorporating additional factors (e.g., such as storage node workload, capacity, or geographical location), by utilizing a dynamic threshold instead of a fixed minimum threshold, by implementing a feedback loop to adjust the threshold based on system performance, by utilizing machine learning or optimization techniques to improve storage node selection and reduce energy consumption, and/or the like.

As further shown in FIG. 2D, and by reference number 250, the sustainability system 210 may write slices of the object to the subset of the plurality of storage nodes 205. For example, the sustainability system 210 may divide the object into smaller, equal-sized chunks, called slices. The number of slices may be determined based on the object's size, the write threshold, and the capacity of the storage nodes 205. The sustainability system 210 may generate a write request for each slice of the object, specifying the slice's data, to which storage nodes 205 to write, and any necessary write parameters (e.g., write type and consistency level). The sustainability system 210 may provide the slices to the subset of the plurality of storage nodes 205 using a data transfer protocol. The subset of storage nodes 205 may write the slices to their respective storage mediums (e.g., hard drives) using a write cache, a buffer, or other optimizations to improve performance. The subset of storage nodes 205 may provide an acknowledgement to the sustainability system 210 indicating the successful completion of the write operation. The sustainability system 210 may verify that the slices were written correctly to the subset of storage nodes 205 by checking the integrity, consistency, and availability of the slices.

As shown in FIG. 2E, and by reference number 255, the sustainability system 210 may determine whether the sustainability ratings for remaining storage nodes 205, other than the subset of the plurality of storage nodes 205, improve in a future time period. For example, the sustainability system 210 may utilize a prediction model to forecast the sustainability ratings of the remaining storage nodes 205 in the future time period. The prediction model may include a linear regression model, a decision tree model, a random forest model, a support vector machine model, a neural network model, and/or the like. The sustainability system 210 may evaluate the accuracy of the forecasted sustainability ratings by calculating forecast errors using metrics, such as a mean absolute error, a mean squared error, a root mean squared percentage error, and/or the like. In some implementations, the sustainability system 210 may compare the forecasted sustainability ratings of the remaining storage nodes 205 to current sustainability ratings of the remaining storage nodes 205. This may include evaluating whether the forecasted sustainability ratings improve by a certain threshold (e.g., 10%), satisfy a target sustainability rating, show a trend of improvement over time, and/or the like. In some implementations, the sustainability system 210 may determine that the sustainability ratings for remaining storage nodes 205 improve in the future time period. Alternatively, the sustainability system 210 may determine that the sustainability ratings for remaining storage nodes 205 fail to improve in the future time period.

As further shown in FIG. 2E, and by reference number 260, the sustainability system 210 may queue remaining slices of the object based on determining that the sustainability ratings for the remaining storage nodes 205 improve in the future time period. For example, if the sustainability system 210 determines that the sustainability ratings for the remaining storage nodes 205 improve in the future time period, the sustainability system 210 may queue remaining slices of the object for the remaining storage nodes 205. In some implementations, the sustainability system 210 may identify the remaining slices of the object that have not been written to the storage nodes 205, and may create a queue to store the remaining slices of the object. The sustainability system 210 may prioritize the remaining slices of the object based on importance and the forecasted sustainability ratings of the remaining storage nodes 205. This may include assigning a priority level to each slice, with higher priority slices being written first. The sustainability system 210 may store the remaining slices of the object in the queue in the order of their priority, and may schedule write operations for the queued slices of the object. When the sustainability ratings of the remaining storage nodes 205 satisfy the required threshold, the sustainability system 210 may write the slices from the queue to the remaining storage nodes 205.

As further shown in FIG. 2E, and by reference number 265, the sustainability system 210 may write the remaining slices of the object to the remaining storage nodes 205 based on determining that the sustainability ratings for the remaining storage nodes 205 do not improve in the future time period. For example, if the sustainability system 210 determines that the sustainability ratings for the remaining storage nodes 205 fail to improve in the future time period, the sustainability system 210 may immediately write the remaining slices of the object to the remaining storage nodes 205. In this way, the sustainability system 210 may write the remaining slices when the sustainability ratings for the remaining storage nodes 205 are at their highest levels.

As shown in FIG. 2F, and by reference number 270, the sustainability system 210 may receive a read request to read an object from the system. For example, the sustainability system 210 may receive the read request (e.g., to read the object from the system) from an external source, such as an application, a user, or another system. The read request may be in the form of an API call, a message, or a command. The read request may include an object identifier (e.g., an object name or an object hash), read parameters (e.g., a read type, a consistency level, and a timeout), authentication and authorization credentials (e.g., a username, a password, or a token), and/or the like. The sustainability system 210 may authenticate and authorize the read request to ensure that a requesting entity has the necessary permissions to access the object. This may include verifying the authentication credentials, checking the requesting entity's access control permissions (e.g., read, write, or delete), and validating the read request against any specific access policies or rules.

In some implementations, the sustainability system 210 may identify the object in the system by searching for the object in a metadata database or by querying the plurality of storage nodes 205. This may include searching for the object's metadata and checking the object's availability and consistency across the plurality of storage nodes 205. The sustainability system 210 may determine the read type based on the read parameters by checking the read type (e.g., synchronous, asynchronous, or streaming) and verifying the consistency level (e.g., strong, weak, or eventual).

As further shown in FIG. 2F, and by reference number 275, the sustainability system 210 may identify a first subset of the plurality of storage nodes 205 equal to the read threshold based on the sustainability ratings. For example, the sustainability system 210 may identify the first subset of the plurality of storage nodes 205 that will handle the read request. This may include identifying the storage nodes 205 that have slices of the object, checking the availabilities and capacities of the identified storage nodes 205, and selecting the first subset of storage nodes 205 based on the sustainability ratings (e.g., energy efficiency and carbon footprint) of the identified storage nodes 205. In some implementations, the first subset of storage nodes 205 may include a quantity of storage nodes 205 that is equivalent to the read threshold (e.g., a minimum number of storage nodes 205 required to complete the read operation).

As further shown in FIG. 2F, and by reference number 280, the sustainability system 210 may select a second subset of the plurality of storage nodes 205 from the first subset based on additional factors. For example, the sustainability system 210 may evaluate additional factors that may impact the selection of the second subset of storage nodes 205. In some implementations, the additional factors may include load balancing, power consumption, temperature, humidity, vibration, and/or the like. For example, the sustainability system 210 may consider the current load on each storage node 205 in the first subset and may select storage nodes 205 for the second subset that are not heavily loaded, to ensure efficient read operations. The sustainability system 210 may consider the power consumption of each storage node 205 in the first subset and may select storage nodes 205 for the second subset that are more energy-efficient, to reduce the overall power consumption. The sustainability system 210 may consider the temperature, the humidity, and the vibration of each storage node 205 in the first subset and may select storage nodes for the second subset that are operating within an optimal temperature range, an optimal humidity range, and an optimal vibration range to ensure reliable read operations.

The sustainability system 210 may assign weights to each of the additional factors based on relative importance, and may calculate a score for each storage node 205 in the first subset based on the additional factors and their assigned weights. The sustainability system 210 may rank the storage nodes 205 in the first subset based on their scores and in a ranked list. The storage nodes 205 with the highest scores may be ranked first, and the storage nodes 205 with the lowest scores may be ranked last. The sustainability system 210 may select the second subset of storage nodes 205 from the ranked list. The number of storage nodes selected for the second subset may be based on the read requirements, such as the number of storage nodes 205 required to satisfy the read threshold.

As further shown in FIG. 2F, and by reference number 285, the sustainability system 210 may read slices of the object from the second subset of the plurality of storage nodes 205. For example, the sustainability system 210 may determine the read type for the slices of the object by checking the read request parameters to determine whether the read operation is synchronous or asynchronous. The sustainability system 210 calculate the read threshold for the slices of the object. This may include determining the minimum number of storage nodes 205 required to read the slices based on the read type and the redundancy scheme. The sustainability system 210 may read the slices of the object from the second subset of storage nodes 205. This may include sending read requests to the storage nodes 205 in the second subset, receiving the slices from the storage nodes 205, and verifying the integrity of the slices using checksums or digital signatures. The sustainability system 210 may reconstruct the object from the slices read from the second subset of storage nodes 205. This may include concatenating the slices to form the complete object and verifying the integrity of the reconstructed object. The sustainability system 210 may return the reconstructed object to the requesting application or user.

In this way, the computer system (e.g., the sustainability system 210) dynamically manages storage node selection for sustainability. For example, the computer system may analyze metrics influencing carbon and heat generation footprints of all storage nodes in an object storage system and may update sustainability ratings for each storage node based on the metrics analysis. The computer system may predict dynamically changing metrics that impact the sustainability, and may read or write slices of objects from or to the storage nodes with high sustainability ratings, ensuring that generated carbon footprint and heat are relatively low. Thus, the computer system may reduce heat generated by the object storage system, may increase utilization of renewable energy sources, and may minimize the need for excessive cooling and energy consumption in the object storage system. Thus, the computer system conserves computing resources, networking resources, and/or the like that would otherwise have been consumed by managing increased energy consumption associated with object storage systems, handling legal and environmental implications of neglecting sustainability in object storage systems, managing increased heat generation associated with object storage systems, and/or the like.

As indicated above, FIGS. 2A-2F are provided as an example. Other examples may differ from what is described with regard to FIGS. 2A-2F. The number and arrangement of devices shown in FIGS. 2A-2F are provided as an example. In practice, there may be additional devices, fewer devices, different devices, or differently arranged devices than those shown in FIGS. 2A-2F. Furthermore, two or more devices shown in FIGS. 2A-2F may be implemented within a single device, or a single device shown in FIGS. 2A-2F may be implemented as multiple, distributed devices. Additionally, or alternatively, a set of devices (e.g., one or more devices) shown in FIGS. 2A-2F may perform one or more functions described as being performed by another set of devices shown in FIGS. 2A-2F.

FIG. 3 is a flowchart of an example process 300 associated with dynamically managing storage node selection for sustainability. One or more process blocks of FIG. 3 are performed by a computer system (e.g., computer 102, one of the storage nodes 205-1 through 205-N, and/or the sustainability system 210) and/or by another device or a group of devices separate from or including the computer system. Additionally, or alternatively, one or more process blocks of FIG. 3 may be performed by one or more components of computer 102, such as processor set 114, communication fabric 116, volatile memory 118, and/or sustainable storage code 150.

As shown in FIG. 3, process 300 may include determining internal factors influencing carbon and generated heat footprints of a plurality of storage nodes of a system with a width, a write threshold, and a read threshold (block 310). For example, the computer system may determine internal factors influencing carbon and generated heat footprints of a plurality of storage nodes of a system with a width, a write threshold, and a read threshold, as described above. In some implementations, the system is an object storage system. In some implementations, the internal factors include one or more of a hardware efficiency, a workload intensity, a layout and design, a cooling systems efficiency, a cooling efficiency, or renewable energy usage associated with each of the plurality of storage nodes.

As further shown in FIG. 3, process 300 may include determining external factors influencing the carbon and generated heat footprints of the plurality of storage nodes (block 320). For example, the computer system may determine external factors influencing the carbon and generated heat footprints of the plurality of storage nodes, as described above. In some implementations, the external factors include one or more of a climate, a geographical location, or an electricity grid carbon intensity associated with the system.

As further shown in FIG. 3, process 300 may include predicting dynamic factors influencing the carbon and generated heat footprints of the plurality of storage nodes (block 330). For example, the computer system may predict dynamic factors influencing the carbon and generated heat footprints of the plurality of storage nodes, as described above. In some implementations, predicting the dynamic factors influencing the carbon and generated heat footprints of the plurality of storage nodes includes utilizing a prediction model to predict the dynamic factors influencing the carbon and generated heat footprints of the plurality of storage nodes. In some implementations, the dynamic factors include one or more of the internal factors that change over time and one or more of the external factors that change over time.

As further shown in FIG. 3, process 300 may include calculating respective sustainability ratings for the plurality of storage nodes based on the internal factors, the external factors, and the dynamic factors (block 340). For example, the computer system may calculate respective sustainability ratings for the plurality of storage nodes based on the internal factors, the external factors, and the dynamic factors, as described above.

As further shown in FIG. 3, process 300 may include utilizing the sustainability ratings to manage the system (block 350). For example, the computer system may utilize the sustainability ratings to manage the system, as described above.

In some implementations, process 300 includes receiving a write request to write an object to the system, identifying a subset of the plurality of storage nodes equal to the write threshold based on the sustainability ratings, and writing slices of the object to the subset of the plurality of storage nodes. In some implementations, process 300 includes determining whether the sustainability ratings for remaining storage nodes, other than the subset of the plurality of storage nodes, improve in a future time period. In some implementations, process 300 includes queuing remaining slices of the object based on determining that the sustainability ratings for the remaining storage nodes improve in the future time period. In some implementations, process 300 includes writing the remaining slices of the object to the remaining storage nodes based on determining that the sustainability ratings for the remaining storage nodes do not improve in the future time period.

In some implementations, process 300 includes receiving a read request to read an object from the system, identifying a first subset of the plurality of storage nodes equal to the read threshold based on the sustainability ratings, selecting a second subset of the plurality of storage nodes from the first subset based on additional factors, and reading slices of the object from the second subset of the plurality of storage nodes. In some implementations, the additional factors include one or more of a load on the system, a latency requirement for the read request, or a storage space of the system. In some implementations, process 300 includes identifying a change in one or more of the internal factors, the external factors, or the dynamic factors, and updating the sustainability ratings of the plurality of storage nodes based on the change in one or more of the internal factors, the external factors, or the dynamic factors.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
determining internal factors influencing carbon and generated heat footprints of a plurality of storage nodes of a system with a width, a write threshold, and a read threshold;
determining external factors influencing the carbon and generated heat footprints of the plurality of storage nodes;
predicting dynamic factors influencing the carbon and generated heat footprints of the plurality of storage nodes;
calculating respective sustainability ratings for the plurality of storage nodes based on the internal factors, the external factors, and the dynamic factors; and
utilizing the sustainability ratings to manage the system.

2. The method of claim 1, wherein the system is an object storage system.

3. The method of claim 1, further comprising:
receiving a write request to write an object to the system;
identifying a subset of the plurality of storage nodes equal to the write threshold based on the sustainability ratings; and
writing slices of the object to the subset of the plurality of storage nodes.

4. The method of claim 3, further comprising:
determining whether the sustainability ratings for remaining storage nodes, other than the subset of the plurality of storage nodes, improve in a future time period.

5. The method of claim 4, further comprising:
queuing remaining slices of the object based on determining that the sustainability ratings for the remaining storage nodes improve in the future time period.

6. The method of claim 5, further comprising:
writing the remaining slices of the object to the remaining storage nodes based on determining that the sustainability ratings for the remaining storage nodes do not improve in the future time period.

7. The method of claim 1, wherein the internal factors include one or more of a hardware efficiency, a workload intensity, a layout and design, a cooling systems efficiency, a cooling efficiency, or renewable energy usage associated with each of the plurality of storage nodes.

8. A computer system, comprising:
a processor set;
one or more computer-readable storage media; and
program instructions stored on the one or more computer-readable storage media to cause the processor set to perform operations comprising:
determining internal factors influencing carbon and generated heat footprints of a plurality of storage nodes of a system with a width, a write threshold, and a read threshold,
wherein the internal factors include one or more of a hardware efficiency, a workload intensity, a layout and design, a cooling systems efficiency, a cooling efficiency, or renewable energy usage associated with each of the plurality of storage nodes;
determining external factors influencing the carbon and generated heat footprints of the plurality of storage nodes;
predicting dynamic factors influencing the carbon and generated heat footprints of the plurality of storage nodes;
calculating respective sustainability ratings for the plurality of storage nodes based on the internal factors, the external factors, and the dynamic factors; and
utilizing the sustainability ratings to manage the system.

9. The computer system of claim 8, wherein the operations further comprise:
receiving a read request to read an object from the system;
identifying a first subset of the plurality of storage nodes equal to the read threshold based on the sustainability ratings;
selecting a second subset of the plurality of storage nodes from the first subset based on additional factors; and
reading slices of the object from the second subset of the plurality of storage nodes.

10. The computer system of claim 9, wherein the additional factors include one or more of a load on the system, a latency requirement for the read request, or a storage space of the system.

11. The computer system of claim 8, wherein the external factors include one or more of a climate, a geographical location, or an electricity grid carbon intensity associated with the system.

12. The computer system of claim 8, wherein predicting the dynamic factors influencing the carbon and generated heat footprints of the plurality of storage nodes comprises:
utilizing a prediction model to predict the dynamic factors influencing the carbon and generated heat footprints of the plurality of storage nodes.

13. The computer system of claim 8, wherein the operations further comprise:
identifying a change in one or more of the internal factors, the external factors, or the dynamic factors; and
updating the sustainability ratings of the plurality of storage nodes based on the change in the one or more of the internal factors, the external factors, or the dynamic factors.

14. The computer system of claim 8, wherein the dynamic factors include one or more of the internal factors that change over time and one or more of the external factors that change over time.

15. A computer program product, comprising:
one or more computer-readable storage media; and
program instructions stored on the one or more computer-readable storage media to perform operations comprising:
determining internal factors influencing carbon and generated heat footprints of a plurality of storage nodes of a system with a width, a write threshold, and a read threshold;
determining external factors influencing the carbon and generated heat footprints of the plurality of storage nodes,
wherein the external factors include one or more of a climate, a geographical location, or an electricity grid carbon intensity associated with the system;
predicting dynamic factors influencing the carbon and generated heat footprints of the plurality of storage nodes;
calculating respective sustainability ratings for the plurality of storage nodes based on the internal factors, the external factors, and the dynamic factors; and
utilizing the sustainability ratings to manage the system.

16. The computer program product of claim 15, wherein the operations further comprise:
receiving a write request to write an object to the system;
identifying a subset of the plurality of storage nodes equal to the write threshold based on the sustainability ratings; and
writing slices of the object to the subset of the plurality of storage nodes.

17. The computer program product of claim 16, wherein the operations further comprise:
determining whether the sustainability ratings for remaining storage nodes, other than the subset of the plurality of storage nodes, improve in a future time period.

18. The computer program product of claim 17, wherein the operations further comprise:
queuing remaining slices of the object based on determining that the sustainability ratings for the remaining storage nodes improve in the future time period.

19. The computer program product of claim 18, wherein the operations further comprise:
writing the remaining slices of the object to the remaining storage nodes based on determining that the sustainability ratings for the remaining storage nodes do not improve in the future time period.

20. The computer program product of claim 15, wherein the operations further comprise:
receiving a read request to read an object from the system;
identifying a first subset of the plurality of storage nodes equal to the read threshold based on the sustainability ratings;
selecting a second subset of the plurality of storage nodes from the first subset based on additional factors; and
reading slices of the object from the second subset of the plurality of storage nodes.
